(19) United States
(12) Patent Application Publication
(10) Pub. No.: US 2016/0031323 A1
(43) Pub. Date: Feb. 4, 2016

(54) SYSTEM AND METHOD OF CONTROLLING CONTACTOR TIP ASSEMBLY

(71) Applicant: Caterpillar Inc., Peoria, IL (US)

(72) Inventor: Benjamin P. Gottemoller, Princeville, IL (US)

(73) Assignee: Caterpillar Inc., Peoria, IL (US)

(21) Appl. No.: 14/879,097

(22) Filed: Oct. 9, 2015

(51) Int. Cl. B60L 3/00; B60L 7/14

(52) U.S. Cl. CPC B60L 3/003; B60L 7/14; B60L 3/0076

(57) ABSTRACT

The present disclosure is related to a method to control a contactor tip assembly associated with a grid of an electric drive system is provided. The contactor tip assembly includes at least one first contactor tip and at least one second contactor tip. The method includes introducing a delay signal associated with an operation of at least one of the first contactor tip and the second contactor tip. Further, the operation includes a closing event and an opening event thereof. The method also includes controlling the operation of the first and second contactor tips in an alternate manner. Further, a delay is present between a sequential operation of one of the first and second contactor tips and the other of the first and second contactor tips based, at least in part, on the introduced delay signal.

### TECHNICAL FIELD

The present disclosure relates to an electric drive braking system associated with a machine, and more particularly to a system and method for controlling an operation of a contactor tip assembly associated with a grid of the electric drive braking system of a machine.

### BACKGROUND

Electric drive machines, such as electric drive mining trucks are commonly used in mining, heavy construction, quarrying, and other applications. These machines may include a regenerative braking system or a dynamic braking system that extracts energy from the propulsion motors during braking [FYI: The energy is dissipated today, not used for machine operation]. The machines also include a pair of contactors that transfers the excess power generated from the wheels to a resistor grid during braking operations. Each of the contactor includes two contactor tips that come together when that contactor closes. The contactor tips of each contactor are subjected to electrical arcing during closing and opening events. During the closing event the electrical arcing is produced between the tips of the contactor that closes later. Alternatively, during the opening event the electrical arcing is produced between the tips of the contactor that opens earlier. The contactor tips are prone to wear during operation due to this electrical arcing. Due to this wear, the contactor tips may require frequent replacement. However, the extent of wear on the tips of each of the contactors is often not the same. Typically, one of the contactor tips wears out to a very great extent as compared to the other contactor tip. Uneven wear of the contactor tips leads to frequent servicing, increasing system downtime and increasing the cost of maintenance.

U.S. Pat. No. 4,479,080, hereinafter referred as the '080 patent, describes electrical braking control for direct current motors. The electric braking control includes an electrical braking control circuit for use in a control system for a direct current traction motor which may be employed, for example, to propel an electrically driven vehicle. The electrical braking controller initiates electrical braking in a plug mode of braking and then, when conditions are suitable for regenerative braking, causes a transition to regenerative braking, followed by return to a plug mode of braking whenever regenerative braking can no longer be efficiently achieved, all of which is carried out smoothly and efficiently without unduly wasting regenerative power. However, the '080 patent does not address the wear of the contactor tips during regenerative braking.

### SUMMARY OF THE DISCLOSURE

In one aspect of the present disclosure, a method to control a contactor tip assembly associated with a grid of an electric drive system is provided. The grid of the electric drive braking system includes a first contactor and a second contactor. The method includes introducing a delay signal associated with an operation of at least one of the first contactor and the second contactor. The operation includes a closing event and an opening event thereof. The method also includes controlling the operation of the first and second contactor in an alternate manner. Further, a delay is present between a sequential operation of one of the first and second contactor and the other of the first and second contactor based, at least in part, on the introduced delay signal.

Other features and aspects of this disclosure will be apparent from the following description and the accompanying drawings.

### BRIEF DESCRIPTION OF THE DRAWINGS

FIG. 1 is a side view of an exemplary machine having an electric drive system disposed within a regenerative braking system, according to an embodiment of the present disclosure;

FIG. 2 is a block diagram of the electric drive system, according to an embodiment of the present disclosure;

FIG. 3 is a circuit diagram showing an exemplary contactor tip assembly associated with the electric drive braking system of FIG. 1, according to an embodiment of the present disclosure; and

FIG. 4 is a flowchart of a method for switching of the contactor tip assembly of FIG. 3 associated with a grid of the electric drive braking system of the machine of FIG. 1, according to an embodiment of the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

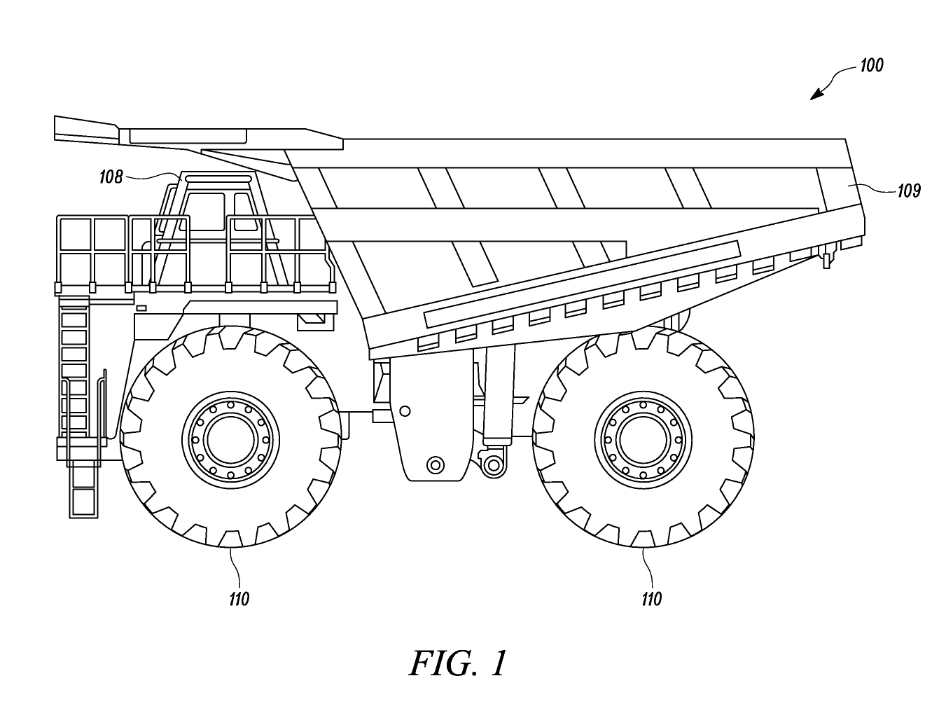

Referring to FIG. 1, an exemplary machine 100 is illustrated according to one embodiment of the present disclosure. The machine 100 is a mining truck with an electric drive system 200. Alternatively, the machine 100 may include any other machine 100, such as, for example, an excavator, a loader, a dozer, a track type tractor, or any other machine including a regenerative or dynamic braking system (not shown). The electric drive system 200 is capable of driving a set of drive wheels 110 to propel the machine 100.

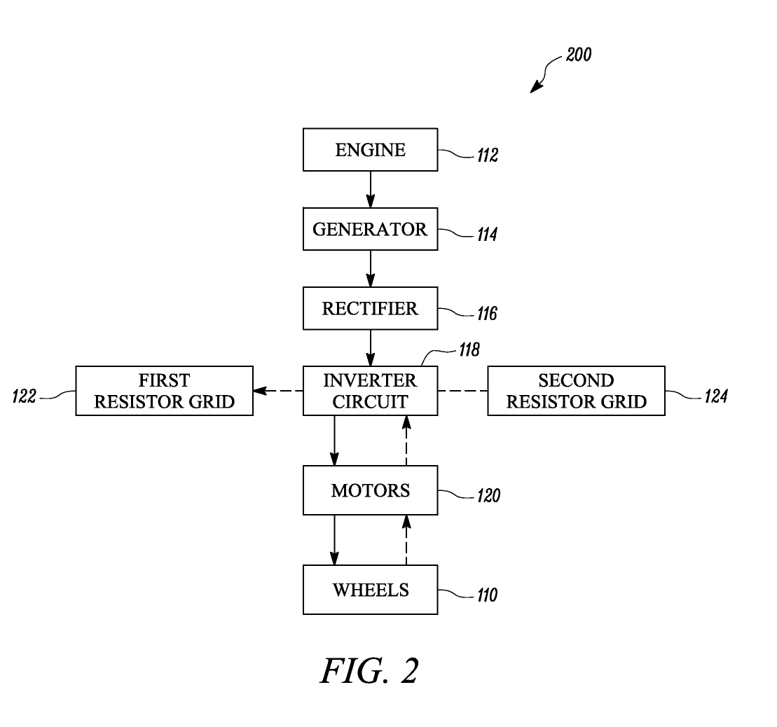

The machine 100 includes an engine 112 (shown in FIG. 2). The engine 112 may be an internal combustion engine which runs on diesel, gasoline, gaseous fuels, or a combination thereof. The engine 112 may be of various configurations, such as in-line, V-type etc. The machine 100 includes an operator cabin 108 mounted on a frame of the machine 100. The operator cabin 108 may include multiple control devices that are used to control the machine 100 for various operations. The machine 100 also includes an implement 109 that is a dump body. In an alternate embodiment the implement 109 may be a bucket, ripper, and the like.

FIG. 2 is a schematic block diagram of the electric drive system 200 of the machine 100. In one embodiment, when the machine 100 propels at a constant velocity or accelerates, the engine 112 produces mechanical power in the form of output torque at an output shaft (not shown). The output shaft transfers the mechanical power to a generator 114. The solid lines as shown in FIG. 2 denote the flow of power. The generator 114 converts the input mechanical power to electrical power. The electrical power generated is in the form of alternating current. Further, the alternating current passes through a rectifier 116, to be converted to direct current. The direct current is then passed to an inverter circuit 118. The inverter circuit 118 may be capable of selectively adjusting the frequency and/or pulse-width of its output. Further, the inverter circuit 118 supplies the input current to a set of motors 120. The inverter circuit 118 operates the motors 120 at variable speeds. The motors 120 may be connected via final assemblies (not shown) or directly to the drive wheels 110 of the machine 100.

When the machine 100 is retarding, the machine 100 undergoes regenerative braking. During regenerative braking the kinetic energy of the machine 100 is transferred into rotational power of the drive wheels 110 that rotates the motors 120, which act as electrical generators. The electrical power generated by the motors 120 has an alternating current waveform. The power supplied by the motors 120 is rectified by the inverter circuit 118 into direct current power. The dissipation of the direct current power generated by the motors 120 produces a counter-rotational torque at the drive wheels 110 to decelerate the machine 100. The dissipation of the direct current power is accomplished by passing the generated current through a first and a second resistance grid 122, 124. The flow of power during the retarding mode is shown in FIG. 2 as dash-lined arrows.

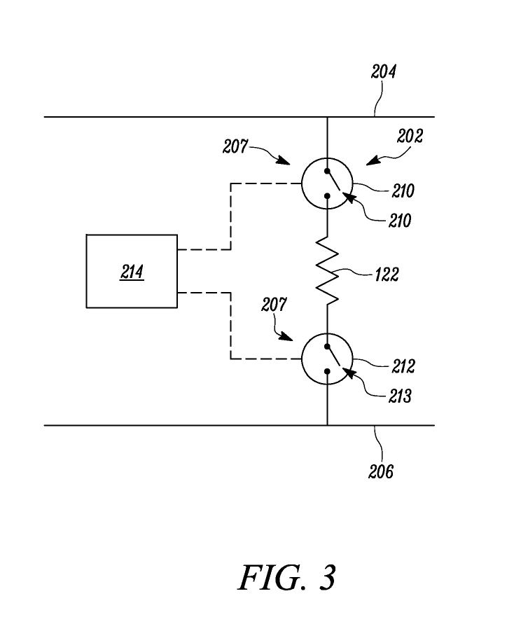

The electric drive system 200 includes a first resistor grid 122 and a second resistor grid 124. The first resistor grid 122 is arranged to receive current from the inverter circuit 118 via a contactor tip assembly 207 as shown in FIG. 3. The second resistor grid 124 is arranged to receive power from a chopper (not shown). The first resistor grid 122 dissipates the direct current power at a uniform rate. The second resistor grid 124 dissipates the direct current power at variable rate.

FIG. 3 depicts an embodiment in which the first resistor grid 122 is configured to dissipate the excess electrical energy produced when the machine 100 is retarding. As shown in FIG. 3, the first resistor grid 122 is associated with the electric drive system 200 of the machine 100. Also, only a portion of the electric drive system 200 is shown in FIG. 3 for the purpose of simplicity and clarity. The electric drive system 200 includes a first direct current link 204 and a second direct current link 206. The first and second direct current links 204, 206 are configured to receive power from the inverter circuit 118.

The first resistor grid 122 of the electric drive system 200 is selectively electrically isolated from the first and second direct current links 204, 206 by a first contactor 210 and a second contactor 212 based on an operation of the contactor tip assembly 207. Each of the first and second contactors 210, 212 includes the contactor tip assembly 207. The contactor tip assembly 207 includes a first pair of contactor tips 211 within the first contactor tip 210 and a second pair of contactor tips 213 within the second contactor tip 212 in the accompanying figures, one first contactor tip 210 and one second contactor tip 212 are illustrated for exemplary purposes. As stated earlier, the electric drive braking grid 202 may additionally include other components not described herein.

The first and second contactor 210, 212 are operated by an actuating mechanism, for example, a solenoid (not shown) or a coil creating a magnetic force that attracts the pair of contactors to make contact. Further, the contacting between the pairs of contactors within the first and second pair of contactor tips 211, 213 alternates between an open position and a closed position, thereby governing an opening event and a closing event of the respective contactors 210, 212. The opening event of any one or both of the first and second contactor 210, 212 inhibits the flow of direct current between the first and second direct current links 204, 206. Whereas, the closing event of both the first and second contactors 210, 212 allows the flow of direct current between the first and second direct current links 204, 206.

In the present embodiment, the closing event and/or the opening event of the first and second contactors 210, 212 are controlled by a control unit 214. The first and second contactors 210, 212 are communicably coupled with the control unit 214. The control unit 214 may be configured to receive signals from one or more sensors (not shown) of the machine 100. Additionally, the control unit 214 may also perform various control operations based on predetermined control strategies stored in a memory associated with the control unit 214. The control unit 214 may be embodied as a microcontroller, a computer, and the like. In one example, the control unit 214 may be configured to regulate the engine 112, and various other components of the machine 100.

In the present disclosure, the control unit 214 is configured to introduce a delay signal in any one of the opening event and the closing event or both events of the contactor tip assembly 207, such that the first and second contactors 210, 212 are operated in an alternate manner. An exemplary working of the system will now be described. Referring to FIGS. 2 and 3, during retardation, a voltage difference is developed across the first and second direct current links 204, 206 by the inverter or the rectifier 116. In an initial state, both the pairs of the first and second contactor tips 211, 213 are in the open position as shown in FIG. 2. The control unit 214 receives a signal from various sensors to realize the closing event of the contactor tip assembly 207. In one embodiment, a first cycle demands the closing event and the opening event of the pairs of the first and second contactor tips 211, 213. In the closing event, the control unit 214 initially closes one of the pairs of the contactor tips, for example, the first contactor tip 211. Further, the control unit 214 sends the delay signal for closing of the pair second contactor tip 213. The delay signal introduces a time lag between the closing of the first contactor 210 and the second contactor 212. The second contactor 212 closes after a lag in time, for example, approximately few milliseconds later than the first contactor 210. After the closing events of both of the first and second contactors 210, 212, the current flows from the first direct current link 204, to the second direct current link 206. The progression of sequencing of closing of the first and the second contactor tip 210, 212 is stored in the memory of the control unit 214.

During the opening event the control unit 214 opens the pairs 211 and 213 of the first and second contactors 210, 212 respectively based on the sequence stored in the memory of the control unit 214. The control unit 214 alters the opening event by first opening the pair of second contactor tips 213 of the second contactor 212. Further, the control unit 214 sends the delay signal for opening of the first contactor tip 211. It should be noted that the delay may be predetermined based on the application requirements.

The delay introduced by the control unit 214 in the operation of the contactor tip assembly 207 is such that the delay is introduced in a closing or opening command to any one of the first and second contactor tips 211, 213. Further, the control unit 214 toggles the delay signals between the first and second contactor 210, 212, such that each of the contactor tips 211, 213 receive the delay signal in turns. The delay thus causes a sequential operation or consecutive operation of the first and second contactors 210, 212 in the subsequent cycles in a controlled and alternate manner.

The working of the contactor tip assembly 207 described herein is exemplary and does not limit the scope of the disclosure. The system may additionally include other components not described herein. Further, the functionality of the control unit 214 may not be limited to that described herein. In one embodiment, an electronic control module (ECM) of the machine 100 may perform the functionality of the control unit 214.

### INDUSTRIAL APPLICABILITY

The present disclosure relates to the system and method for controlling the switching between the operation of first and second contactors 210, 212 of the contactor tip assembly 207. Accordingly, the control unit 214 introduces the delay signal between the opening and/or closing events of the first and second contactors 210, 212 such that the first and second contactor tips 211, 213 are operated in a sequential order.

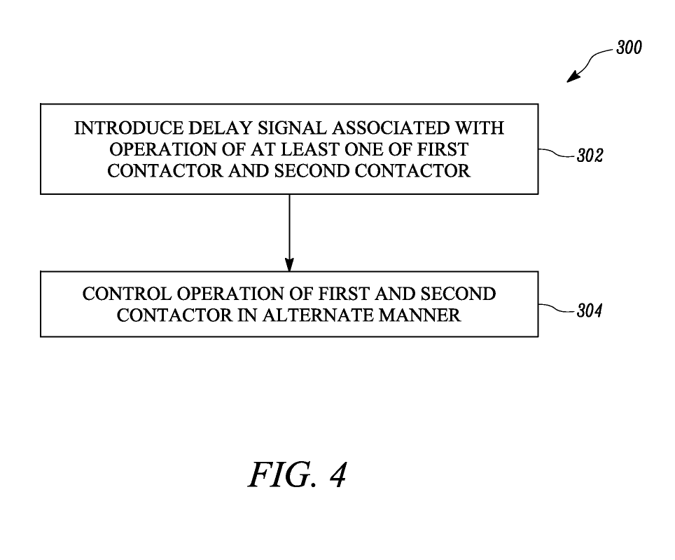

Referring to FIG. 4, a flowchart for a method 300 of switching of the contactor tip assembly 207 is illustrated. At step 302, the control unit 214 introduces the delay signal associated with the operation of the first contactor 210, the second contactor 212, or both. The operation includes the closing event and the opening event thereof.

At step 304, the control unit 214 controls the operation of the first and second contactor 210, 212 in the alternate manner. The operation of the first and second contactor 210, 212 are controlled such that the delay is present between the sequential operation of one of the first and second contactors 210, 212 and the other of the first and second contactors 210, 212 based on the introduced delay signal.

The method 300 causes the first and second contactors 210, 212 to operate in a sequential manner in the same cycle and alternate manner in consecutive cycles. Accordingly, the present disclosure evenly distributes the opening and closing of the contactor tips 210, 212 that further ensures uniform wear on the first and second contactor tips 211, 213 of the contactor tip assembly 207. The control unit 214 alternatively operates the first and second contactor tips 211, 213 such that instead of wear of only one of the contactor tips 211, 213, both the first and second contactor tips 211, 213 experience the same extent of wear. Thus, both the first and second contactor tips 211, 213 may be serviced at the same time, reducing system downtime and improving overall system productivity.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method of switching of a contactor tip assembly associated with a grid of an electric drive braking system of a machine, the grid of the electric drive braking system including a first contactor and a second contactor, method comprising:
introducing a delay signal associated with an operation of at least one of the first contactor and the second contactor, wherein the operation includes a closing event and an opening event thereof; and
controlling the operation of the first and second contactor in an alternate manner, wherein a delay is present between a sequential operation of one of the first and second contactor and the other of the first and second contactor based, at least in part, on the introduced delay signal.
